(19) United States
(12) Patent Application Publication
(10) Pub. No.: US 2008/0246585 A1
(43) Pub. Date: Oct. 9, 2008

(54) Vehicle Control System

(76) Inventor: Ciprian Musat, Creteil Cedex (FR)

Correspondence Address: OSHA LIANG L.L.P., 1221 MCKINNEY STREET, SUITE 2800, HOUSTON, TX, 77010, US

(21) Appl. No.: 11/632,437

(22) PCT Filed: Jul. 7, 2005
(86) PCT No.: PCT/EP05/53263

§ 371 Date: Jan. 8, 2008

(30) Foreign Application Priority Data
Jul. 15, 2004 (FR) 0407842

(51) Int. Cl. B60R 25/00; G07C 9/00

(52) U.S. Cl. 340/5.64; 340/5.6

(57) ABSTRACT

The invention relates to a vehicle control system, in particular authorising access to the vehicle by controlling locks and/or actuators operating the vehicle doors. A first wireless communications channel is established between a portable identification unit (7) and a controller (1) mounted in the vehicle. A communications system comprises a second communications channel (4-6; 9, 10) using a currant crossing a body.

The present invention relates to a vehicle control system of the type that is used in particular to provide access to the vehicle by controlling locks and/or actuators operating the doors of the vehicle, or even used to activate or deactivate the unit for starting up the drive train and the other functions that are accessible to the user of the vehicle.

In the state of the art, already described are vehicle control systems comprising a communication controller for the control of the vehicle, the controller being installed on board the vehicle. The on-board communication controller is linked to an identifier, normally in the form of a portable unit. The on-board communication controller and the portable unit communicate with each other via a wireless communication channel. Among wireless communication means, radio-frequency waves in the low-frequency field or in the high-frequency field are often used, as are infrared waves.

More recently, a communication technique implementing a current passing through the body has been used. In particular, this technique offers the advantage of physically connecting the vehicle and the holder of the portable identification unit, which often handles the detection of the physical presence of the holder of the portable unit. By contrast, in the case of a wireless communication channel, the detection of presence of the portable identification unit can be positive although its holder is not present. Such is particularly the case when the portable identification unit has been left inside the vehicle, or when the wireless communication between the portable unit and the controller on board the vehicle has been diverted using radio-frequency waves in particular.

Moreover, there are currently vehicle control systems that use radio-frequency channels and that handle a large number of remote control functions. These systems are often very expensive and are available only for new or top-of-the-range vehicles. There is a need on the market for simpler control systems to be available at lower cost.

To overcome these drawbacks of the state of the art, the present invention relates to a system of communication between a portable identification unit and a controller on board a vehicle fitted with a first wireless communication channel between at least one portable identification unit and a controlling controller on board a vehicle. The invention is characterized in that the communication system comprises a second communication channel using a current passing through the body.

According to another aspect of the invention, the communication channel implementing a current passing through the body is unidirectional and comprises a signal generator associated with the controller on board the vehicle, and a signal receiver associated with the portable identification unit.

According to another aspect of the invention, the communication channel implementing a wireless communication is controlled by the reception of a predetermined message, initiated by the controller on board the vehicle and transmitted via the communication channel implementing a current passing through the body.

According to another aspect of the invention, the portable identification unit is constructed on the basis of a portable identification unit equipped with resources providing a communication channel implementing a current passing through the body, using a second portable identification unit in which a resource is reserved to receive a pre-existing circuit equipped with resources providing a communication channel implementing a wireless communication.

According to another aspect of the invention, the communication channel implementing a wireless communication is a radio-frequency channel.

According to another aspect of the invention, the radio-frequency channel is a high-frequency channel.

According to another aspect of the invention, the controller on board the vehicle is connected to a conductive element joined to a part of the vehicle passenger compartment.

According to another aspect of the invention, the predetermined message is generated by the controller on board the vehicle, based on the detection of a movement and/or an action on the part of the user holding the portable identification unit.

According to another aspect of the invention, the detection of a movement and/or an action on the part of the user is executed on the basis of a capacitive sensor and/or a switch.

According to another aspect of the invention, the predetermined message is generated periodically by the controller on board the vehicle.

According to another aspect of the invention, the portable identification unit comprises a means of activating its electronic components on the basis of the reception of a predetermined message transmitted via the communication channel implementing a current passing through the body.

According to another aspect of the invention, the portable identification unit also comprises a means of generating a message connected to a transmission resource of a communication implementing a current passing through the body.

According to another aspect of the invention, the transmission resource of a communication implementing a current passing through the body cooperates with a means of wirelessly detecting a current passing through the body, mounted on the vehicle and cooperating with the controlling controller on board the vehicle.

According to another aspect of the invention, the controlling controller on board the vehicle cooperates with a plurality of communication means implementing a current passing through the body, each comprising at least one means of generating a signal identifying an area of the vehicle in which the communication implementing a current passing through the body is initiated.

Other characteristics and advantages of the present invention will be better understood from the description and the appended figures, in which:

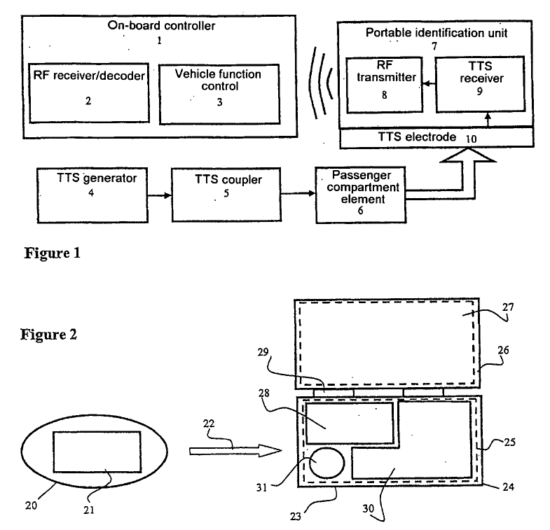

FIG. 1 is a block diagram explaining a particular embodiment of the invention;

FIG. 2 is a block diagram explaining a particular way of constructing a portable identification unit used in a system according to the invention.

FIG. 1 shows a block diagram explaining a particular embodiment of the inventive control system.

The vehicle is not shown, but it comprises a plurality of openings such as the doors, a rear trunk, an engine compartment, and a starter unit known as a starter which is not shown.

It comprises an electrical installation, and in particular a signaling bus over which electronic messages are transferred in digital form.

An on-board controller 1 is used to control functions of the vehicle that are dependent on a portable identification unit 7. Such a controller has already been described in the state of the art and makes it possible, using a radio-frequency receiver/decoder 2 to receive from a radio-frequency transmitter 8 incorporated in the portable identification unit 7 a control message comprising in particular a digital word characteristic of the identification of the holder of the portable identification unit 7.

In particular, as is known in the state of the art, if the control message received and decoded by the receiver/decoder 2 of the on-board controller 1 contains a digital identification word recognized by the controller, the receiver/decoder 2 produces an instruction to activate desired vehicle function controls by action on the vehicle function control module 3.

As is known in particular in the state of the art, such a vehicle function control module 3 can be used:

to activate the opening and/or closing of the doors of the vehicle or of one particular door;

to activate or deactivate the starter unit of the vehicle drive train;

to transmit adjustment parameters from the driver's seat and/or other units fitted in the passenger compartment of the vehicle; and so on.

According to the invention, the inventive vehicle control system also comprises a frame generator module TTS4 (TTS standing for Transmission Through Skin). A TTS frame generator module 4 is designed to set up a communication channel implementing a current passing through the human body of an individual holding a portable identification unit 7. Such a frame generator module TTS4 may or may not be coupled to the on-board controller 1. When the frame generator module TTS4 is coupled to the on-board controller 1, it is connected to it by a control bus, for example via the control bus that has been described above, so as to work in a programmed manner according to the operation and/or the programming of the on-board controller 1 and/or of the radio-frequency receiver/decoder 2.

The frame generator TTS4 is designed in such a way as to produce messages containing predetermined digital information that are transmitted to a TTS communication coupler 5 which produces a modulated electric current which is supplied to a conductive element attached to an element 6 of the vehicle passenger compartment in which the on-board controller 1 is mounted, such as a door handle, a bodywork item, a trim, a bodywork profile, a fuel tank cap, etc.

When the holder of the portable identification unit 7 touches the duly equipped passenger compartment element 6, a current circulating through the body is set up and arrives at a TTS electrode 10 attached to the portable identification unit 7. A TTS receiver module 9 fitted in the portable identification unit 7 then receives the digital message transmitted via the communication channel implementing a current passing through the body. The message received by the TTS receiver module 9 is decoded by the latter, and an activation instruction can then be transmitted to a radio-frequency transmitter 8 carried by the portable identification unit 7.

In particular, the activation instruction can be used to set the various electronic circuits of the portable identification unit 7 to a state of consumption from an electrical source such as an electric battery (not shown) incorporated in the portable identification unit 7. In this activation mode, the radio-frequency transmitter 8 is programmed to read an identification code stored in an electronic memory (not shown) of the portable identification unit 7. The stored identification code is then transmitted via a wireless communication channel, of radio-frequency type, in the form of a predetermined message executed in a predetermined modulation, using the radio-frequency transmitter 8 incorporated in the portable identification unit 7.

The message transmitted via the wireless communication channel can then be received and decoded by the radio-frequency receiver/decoder 2 installed on the on-board controller 1 on the vehicle so as to perform a control to lock or unlock the doors of the vehicle, for example, using the vehicle function control module 3.

In this embodiment represented in FIG. 1, the communication channel implementing a current passing through the body is unidirectional. In another embodiment, the portable identification unit also comprises a TTS modulation transmitter circuit (not shown) which is designed to transmit predetermined information, stored and/or calculated in a programmed manner in the portable identification unit 7 to be communicated to a TTS receiver (not shown) incorporated in or associated with the controller 1 on board the vehicle.

FIG. 2 shows a block diagram explaining a particular way of constructing a portable identification unit used in an inventive vehicle control system.

To construct a portable identification unit according to the invention, a first portable identification unit 20 is used, which comprises a wireless communication means in the form of a printed circuit 21, the dimensions of which are determined from a predetermined range. Similarly, the electrical power supply for the printed circuit is provided via two electric wires which can be detached from the power source (not shown) in the first portable identification unit 20.

Once separated from the first portable identification unit 20, which can be a pre-existing radio-frequency vehicle remote control, the printed circuit 21 which provides a wireless communication is then transferred in an assembly 22 to a second portable identification unit 23 which has been built especially for this purpose and which comprises in particular an electrical power supply such as an electric battery 31 and a printed circuit 30 on which has previously been constructed a communication means implementing a current passing through the body. In particular, the printed circuit 30 is electrically connected by an electric output terminal (not shown) adapted to at least one conductive electrode such as the electrode 25 and/or the electrode 27 on the second portable identification unit 23.

The second portable identification unit 23 is made up of two halves 24 and 26 connected by hinges such as the hinge 29, for example in the form of a housing of a particular predetermined style, and also includes from production an area, the dimensions of which correspond to the range of predetermined dimensions with which the printed circuit 21 of all the first portable identification units 20 comply, that the second portable identification unit 23 can receive.

Once mechanically inserted in the housing 24, 26 forming the second portable identification unit 23, the printed circuit 21 occupies the position 28 and can be connected by its electrical power supply to the battery 31 so as to fulfill the same function in the second portable identification unit 23 as it fulfilled in the first portable identification unit 20.

When constructing the second portable identification unit 23, once the printed circuit 28 providing a wireless communication is inserted in the housing, the latter is pulled shut around the hinges 29 and closed using a closure device that is not shown.

Thus, there has been constructed a novel portable identification unit 23 which comprises a first wireless communication channel, for example of radio-frequency type, and a second communication channel implementing a current passing through the body using the printed circuit 30 and electrodes 25 and 27 that are positioned in such a way as to make contact with the skin of the person holding the second portable identification unit 23.

If the vehicle on which the on-board controller 1 is located has no communication channel implementing a current passing through the body, it is then equipped according to the teaching of FIG. 1 with a TTS message generator, a TTS coupler and a TTS sensor or effector associated with a passenger compartment element 6 so as to form a control system according to the invention.

It will be noted that this arrangement of the invention makes it possible to convert existing vehicle control systems, to benefit from the characteristic advantages of a TTS communication.

In particular, it is also possible in certain cases to provide an electrical connection between the printed circuit 30 and the printed circuit 28 when an appropriate terminal is provided on the printed circuit 28. This way, a dialogue signal can be exchanged between the printed circuit 30 and the printed circuit 28 in the second portable identification unit 7.

In a particular embodiment, the wireless communication channel is a high-frequency radio communication channel. In particular, such an arrangement makes it possible to initiate a short-distance dialogue between the portable identification unit and the controller on board the vehicle on initialization via a communication over the channel implementing a current passing through the body and then to continue this dialogue, or even a long-distance dialogue, using the wireless communication channel using a high-frequency modulated radiation.

There now follows a description of a particular embodiment in which the TTS message generator 4 is activated so as to enable a dialogue in the context of application to a vehicle control system.

In particular, the TTS message generator 4 can work permanently by periodically sending TTS-type interrogation messages, which are then not perceived as long as the user holding a portable identification unit provided with a communication resource implementing a current passing through the body does not touch a conductive element connected to the TTS message generator 4.

In another embodiment, each passenger compartment element 6 provided with a TTS transmitter is also equipped with a means of detecting the presence of a user holding a portable identification unit. Such a detection means comprises a proximity sensor such as a capacitive sensor or even a switch operated by the physical contact between a part of the body of the user and the passenger compartment element 6.

In another embodiment, each particular area of the passenger compartment of the vehicle, outside or inside the latter, and in this case particularly in the driver's position, can be fitted with one or more TTS communication elements. In this case, each area can then be identified using an area identification code which is inserted into the TTS message produced by each TTS generator associated with such an area of the vehicle. In particular, in this case, the inventive portable identification unit can then include a particular program triggered by the detection of such an area identification code. Conversely, when the inventive portable identification unit has received a particular area identification code, it can insert a message enabling the on-board controller 1 to carry out an action corresponding to the area of the passenger compartment and/or the driver's position in which the TTS communication has been conducted by current passing through the body. There is thus an assurance both of the proof that the control is actually executed in the presence of the user on the one hand and, on the other hand, of the indication of a particular area in which the control is carried out. In particular, it is then possible to associate a particular group of control functions of the vehicle with each area or with each area group formed in the passenger compartment or the driver's position.

1. A system of communication between a portable identification unit and a controller on board a vehicle fitted with a first wireless communication channel between at least one portable identification unit and a controlling controller on board a vehicle, wherein the communication system comprises a second communication channel using a current passing through the body.

2. The system as claimed in claim 1, wherein the communication channel implementing a current passing through the body is unidirectional and comprises a signal generator associated with the controller on board the vehicle, and a signal receiver associated with the portable identification unit.

3. The system as claimed in claim 1, wherein the communication channel implementing a wireless communication is controlled by the reception of a predetermined message, initiated by the controller on board the vehicle and transmitted via the communication channel implementing a current passing through the body.

4. The system as claimed in claim 3, wherein the portable identification unit is constructed on the basis of a first portable identification unit equipped with resources providing a communication channel implementing a current passing through the body, using a second portable identification unit in which a resource is reserved to receive a pre-existing circuit equipped with resources providing a communication channel implementing a wireless communication.

5. The system as claimed in claim 1, wherein the communication channel implementing a wireless communication is a radio-frequency channel.

6. The system as claimed in claim 5, wherein the radio-frequency channel is a high-frequency channel.

7. The system as claimed in claim 1, wherein the controller on board the vehicle is connected to a conductive element joined to a part of the vehicle passenger compartment.

8. The system as claimed in claim 3, wherein the predetermined message is generated by the controller on board the vehicle, based on the detection of a movement and/or an action on the part of the user holding the portable identification unit.

9. The system as claimed in claim 8, wherein the detection of a movement and/or an action on the part of the user is executed on the basis of a capacitive sensor and/or a switch.

10. The system as claimed in claim 8, wherein the predetermined message is generated periodically by the controller on board the vehicle.

11. The system as claimed in claim 1, wherein the portable identification unit comprises a means of activating its electronic components on the basis of the reception of a predetermined message transmitted via the communication channel implementing a current passing through the body.

12. The system as claimed in claim 1, wherein the portable identification unit also comprises a means of generating a message connected to a transmission resource of a communication implementing a current passing through the body.

13. The system as claimed in claim 12, wherein the transmission resource of a communication implementing a current passing through the body cooperates with a means of wirelessly detecting a current passing through the body, mounted on the vehicle and cooperating with the controlling controller on board the vehicle.

14. The system as claimed in claim 1, wherein the controlling controller on board the vehicle cooperates with a plurality of communication means implementing a current passing through the body, each comprising at least one means of generating a signal identifying an area of the vehicle in which the communication implementing a current passing through the body is initiated.

15. The system as claimed in claim 4, wherein the predetermined message is generated by the controller on board the vehicle, based on the detection of a movement and/or an action on the part of the user holding the portable identification unit.

16. The system as claimed in claim 5, wherein the predetermined message is generated by the controller on board the vehicle, based on the detection of a movement and/or an action on the part of the user holding the portable identification unit.

17. The system as claimed in claim 6, wherein the predetermined message is generated by the controller on board the vehicle, based on the detection of a movement and/or an action on the part of the user holding the portable identification unit.

18. The system as claimed in claim 7, wherein the predetermined message is generated by the controller on board the vehicle, based on the detection of a movement and/or an action on the part of the user holding the portable identification unit.

19. The system as claimed in claim 9, wherein the predetermined message is generated periodically by the controller on board the vehicle.
